(19) United States
(12) Patent Application Publication
(10) Pub. No.: US 2016/0344818 A1
(43) Pub. Date: Nov. 24, 2016

(54) SYSTEMS AND METHODS FOR MULTI-USER ANONYMOUS COMMUNICATION

(71) Applicant: Cazualy, Inc., Santa Monica, CA (US)

(72) Inventor: Jayesh Bhayani, Santa Monica, CA (US)

(21) Appl. No.: 14/718,676

(22) Filed: May 21, 2015

(51) Int. Cl. H04L 29/08; H04L 29/06

(52) U.S. Cl. CPC H04L 67/141; H04L 67/306; H04L 67/10; H04L 65/1069; H04L 65/403

(57) ABSTRACT

Embodiments of the invention relate to computer-implemented systems, methods, and computer readable media for connecting two or more users in an anonymous communication session. A method includes: receiving a request from a client device of a first user to engage in a communication session with one or more people located in a specified geographic region; sending an invitation to engage in the communication session to client devices of a plurality of users in the specified geographic region; receiving an indication that a second user has accepted the invitation; and facilitating the communication session between the first user and the second user.

### TECHNICAL FIELD

Embodiments of the invention relate to systems and methods for multi-user communication and, more specifically, to systems and methods that allow a user to connect and communicate anonymously with other users in specified geographic locations.

### BACKGROUND

Existing communication systems generally allow users to find and connect with people they already know. Telephones, text chat systems, and video conferencing devices are used mostly to contact people who are known to the users or who can be easily identified by the users. Likewise, social media tools are generally good for finding and staying in touch with people who users already know.

These existing communication systems, however, are not particularly good at allowing users to locate and meet other people who they do not yet know but with whom they may want to communicate. For example, a user may wish to meet and communicate with a new person in a remote geographic location. Such communication may be useful for the user to make a new friend, learn more about a particular culture, and/or learn about any current events happening in the geographic location.

There is a need for new systems and methods that allow users to connect and communicate anonymously with people they do not already know and who are located in specified geographic locations.

### SUMMARY OF THE INVENTION

Embodiments of the systems and methods described herein utilize a mobile application that allows users to meet and communicate with people in specified geographic regions. A user can choose any geographical region (e.g., a city, county, or country) and submit a request to communicate with other users of the systems and methods. Once the request is submitted, the systems and methods search for other users who are located in the geographic region and are available to communicate. The other users may be identified according to certain user information or preferences, including user age, user interests, user feedback ratings, and geographic proximity, to find the best match possible for the user's request. The communication session can be facilitated one-to-one (i.e., between two users) or in a group or conference fashion. The communication may include text, audio, and/or video. The systems and methods protect user privacy by not revealing precise user locations or any personally identifiable information.

Compared to previous approaches, the systems and methods described herein have many advantages. For example, a user who plans to travel to a particular city may find and connect with someone in that city to obtain real-time, localized, and personalized information related to entertainment, restaurants, museums, or anything else the user may wish to know about the city. Similarly, a news agency can use the systems and methods to reach out to a specific geographic region in the event of a disaster or other event, to collect real-time information from people in the region, without having to send a reporter to the region. Relief agencies may use the systems and methods to facilitate sending help to regions in need (e.g., following a natural disaster or an outbreak of disease). The systems and methods also allow users to reach out to people anonymously to ask for advice or to receive real-time, personalized answers to certain questions Likewise, a user may use the systems and methods to chat with people and make new friends in specific geographical locations, much like the concept of pen pals. Users may be connected with other users substantially randomly and/or according to certain factors (e.g., geographic location, user age, or user gender) or common interests (e.g., food, wine, or entertainment). A random connection may make it easier for users to connect with a wider variety of people who they otherwise would be less likely to meet. In general, the systems and methods allow users to meet people they do not already know and to communicate with these people anonymously.

In one aspect, the invention relates to a method that includes using one or more computer processors to perform operations including: receiving a request from a client device of a first user to engage in a communication session with one or more people located in a specified geographic region; identifying at least one second user in the geographic region who is a suitable candidate for the communication session based on a user rating, the user rating including or being based on feedback relating to the at least one second user from a previous communication session; sending an invitation to engage in the communication session to one or more client devices of the at least one second user in the specified geographic region; receiving an indication that the at least one second user has accepted the invitation; and facilitating the communication session between the first user and the at least one second user.

The communication session may include, for example, a text communication, an audio communication, a video communication, and combinations thereof. The specified geographic region may be, for example, a town, a city, a village, a county, a province, and a country. The one or more people may not be known to the first user. In some examples, the at least one second user includes a plurality of second users, and the invitation is sent to the client devices of the plurality of second users simultaneously.

In certain implementations, the request may include a proposed topic for the communication session. The invitation may include the proposed topic for the communication session. The at least one second user may be identified based on a user preference. The one or more client devices of the at least one second user may be or include mobile phones. A distance between the first user and the geographic region is preferably greater than about 10 miles.

In another aspect, the invention relates to a system that includes (i) a non-transitory computer readable medium having instructions stored thereon, and (ii) a data processing apparatus. The data processing apparatus is configured to execute the instructions to perform operations including: receiving a request from a client device of a first user to engage in a communication session with one or more people located in a specified geographic region; identifying at least one second user in the geographic region who is a suitable candidate for the communication session based on a user rating, the user rating including or being based on feedback relating to the at least one second user from a previous communication session; sending an invitation to engage in the communication session to one or more client devices of the at least one second user in the specified geographic region; receiving an indication that the at least one second user has accepted the invitation; and facilitating the communication session between the first user and the at least one second user.

The communication session may include, for example, a text communication, an audio communication, a video communication, and combinations thereof. The specified geographic region may be, for example, a town, a city, a village, a county, a province, and a country. The one or more people may not be known to the first user. In some examples, the at least one second user includes a plurality of second users, and the invitation is sent to the client devices of the plurality of second users simultaneously.

In certain implementations, the request may include a proposed topic for the communication session. The invitation may include the proposed topic for the communication session. The at least one second user may be identified based on a user preference. The one or more client devices of the at least one second user may be or include mobile phones. A distance between the first user and the geographic region is preferably greater than about 10 miles.

In another aspect, the invention relates to a computer program product stored in one or more non-transitory storage media for controlling a processing mode of a data processing apparatus. The computer program product is executable by the data processing apparatus to cause the data processing apparatus to perform operations including: receiving a request from a client device of a first user to engage in a communication session with one or more people located in a specified geographic region; identifying at least one second user in the geographic region who is a suitable candidate for the communication session based on a user rating, the user rating including or being based on feedback relating to the at least one second user from a previous communication session; sending an invitation to engage in the communication session to one or more client devices of the at least one second user in the specified geographic region; receiving an indication that the at least one second user has accepted the invitation; and facilitating the communication session between the first user and the at least one second user.

The communication session may include, for example, a text communication, an audio communication, a video communication, and combinations thereof. The specified geographic region may be, for example, a town, a city, a village, a county, a province, and a country. The one or more people may not be known to the first user. In some examples, the at least one second user includes a plurality of second users, and the invitation is sent to the client devices of the plurality of second users simultaneously.

In certain implementations, the request may include a proposed topic for the communication session. The invitation may include the proposed topic for the communication session. The at least one second user may be identified based on a user preference. The one or more client devices of the at least one second user may be or include mobile phones. A distance between the first user and the geographic region is preferably greater than about 10 miles.

Elements of embodiments described with respect to a given aspect of the invention may be used in various embodiments of another aspect of the invention. For example, it is contemplated that features of dependent claims depending from one independent claim can be used in apparatus and/or methods of any of the other independent claims.

### BRIEF DESCRIPTION OF THE DRAWINGS

The objects and features of the invention can be better understood with reference to the drawings described below, and the claims. The drawings are not necessarily to scale, emphasis instead generally being placed upon illustrating the principles of the invention. In the drawings, like numerals are used to indicate like parts throughout the various views.

While the invention is particularly shown and described herein with reference to specific examples and specific embodiments, it should be understood by those skilled in the art that various changes in form and detail may be made therein without departing from the spirit and scope of the invention.

FIG. 1 is a schematic diagram of a system for connecting two or more users in a communication session, in accordance with certain embodiments of the invention.

FIGS. 2-14 are example screenshots from a client device of the system of FIG. 1, in accordance with certain embodiments of the invention.

FIGS. 15-20 are flowcharts of a method of connecting two or more users in a communication session, in accordance with certain embodiments of the invention.

FIG. 21 is a flowchart of a method of connecting two or more users in a communication session, in accordance with certain embodiments of the invention.

### DESCRIPTION OF THE INVENTION

It is contemplated that apparatus, systems, methods, and processes of the claimed invention encompass variations and adaptations developed using information from the embodiments described herein. Adaptation and/or modification of the apparatus, systems, methods, and processes described herein may be performed by those of ordinary skill in the relevant art.

Throughout the description, where apparatus and systems are described as having, including, or comprising specific components, or where processes and methods are described as having, including, or comprising specific steps, it is contemplated that, additionally, there are apparatus and systems of the present invention that consist essentially of, or consist of, the recited components, and that there are processes and methods according to the present invention that consist essentially of, or consist of, the recited processing steps.

It should be understood that the order of steps or order for performing certain actions is immaterial so long as the invention remains operable. Moreover, two or more steps or actions may be conducted simultaneously.

The systems and methods described herein generally relate to anonymous communication sessions between two or more users. In certain implementations, a “user” is understood to be a person who is using the systems and methods. The user may be a person who is requesting a communication session with one or more other people. Such a user may be referred to as a “requesting user,” a “requester,” an “inviter,” or a “caller.” Alternatively or additionally, the user may be a person with whom the requesting user is requesting the communication session. Such a user may be referred to as a “responding user,” a “responder,” an “invitee,” or a “callee.” A user who participates in a communication session may also be referred to as a “participant.”

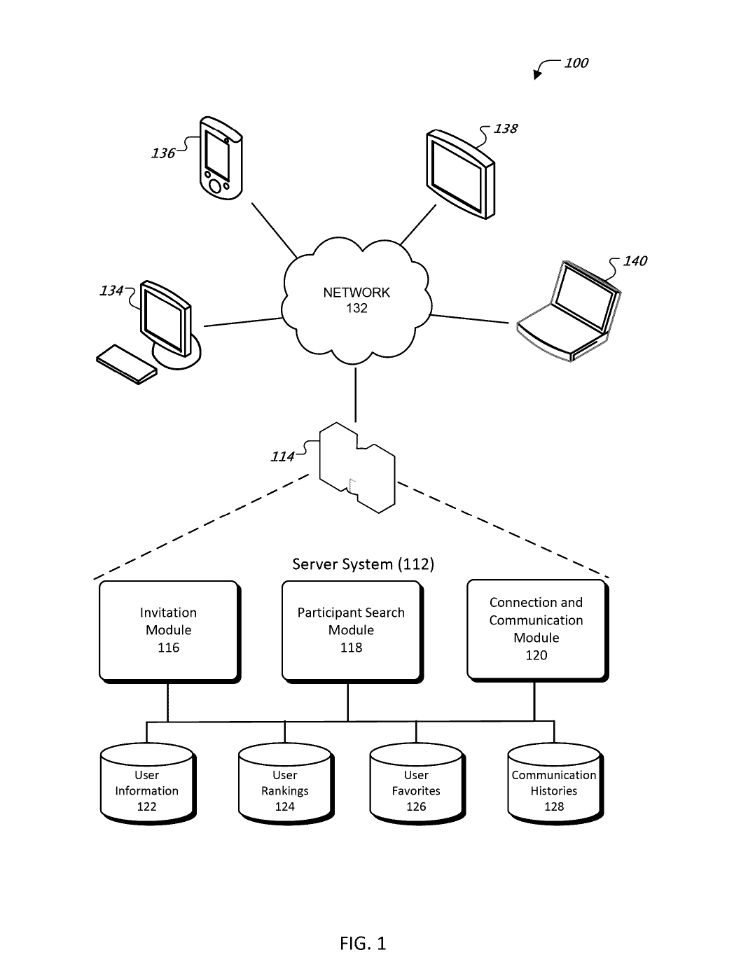

FIG. 1 illustrates an example system 100 for connecting two or more users in an anonymous communication session. A server system 112 provides functionality that allows users to invite other users for the communication session, search for the other users (e.g., based on user preferences), and connect the two or more users. The server system 112 includes software components and databases that can be deployed at one or more data centers 114 in one or more geographic locations, for example. The server system 112 software components include an invitation module 116, a participant search module 118, and a connection and communication module 120. The software components can include subcomponents that can execute on the same or on different individual data processing apparatus. The server system 112 databases include user information 122, user rankings 124, user favorites 126, and communication histories 128. The databases can reside in one or more physical storage systems (e.g., on client devices and/or in one or more remote locations). The software components and databases will be further described below.

An application such as a web-based application can be provided as an end-user application to allow users to interact with the server system 112. The end-user application can be accessed through a network 132 (e.g., the Internet) by users of client devices, such as a personal computer 134, a smart phone 136, a tablet computer 138, and a laptop computer 140. Other client devices are possible.

FIG. 1 depicts the invitation module 116, the participant search module 118, and the connection and communication module 120 as being able to communicate with the databases (i.e., user information 122, user rankings 124, user favorites 126, and communication histories 128). The user information 122 database generally includes information about the users of the system 100, such as user age (e.g., within age ranges), topics of interest (e.g., arts, education, fashion, politics, etc.), gender, and the user's current geographical location. The user information 122 may also include certain user preferences, such as preferred times of day a user may be willing to be contacted by other users and/or a maximum number of times a user is willing to be contacted in a given day. The user rankings 124 database stores feedback received from users about the other users of the system 100. Such feedback may include, for example, a numerical rating by one user of another user regarding the other user's attitude and/or ability to communicate during a previous communication session. The user favorites 126 database generally stores information related to preferred users and/or preferred geographic locations for communication sessions. For example, a user may identify one or more other users as being favorite people to connect with for future communication sessions. The user may also identify certain geographic locations as being preferred locations within which new users are to be found for future communication sessions. The communication histories 128 database may store histories of communication sessions. For example, text chat histories may be stored so that users can revisit information exchanged during a prior text chat session. Users may search through the communication histories for particular conversations, according to, for example, user handle, geographic location, topics, and/or interests. In certain implementations, the text chat histories are stored on client devices of the users (e.g., a personal computer 134, a smart phone 136, a tablet computer 138, and/or a laptop computer 140). Text chat histories may be stored locally (e.g., on user client devices) and/or on the server system 112 (e.g., in the communication histories 128 database).

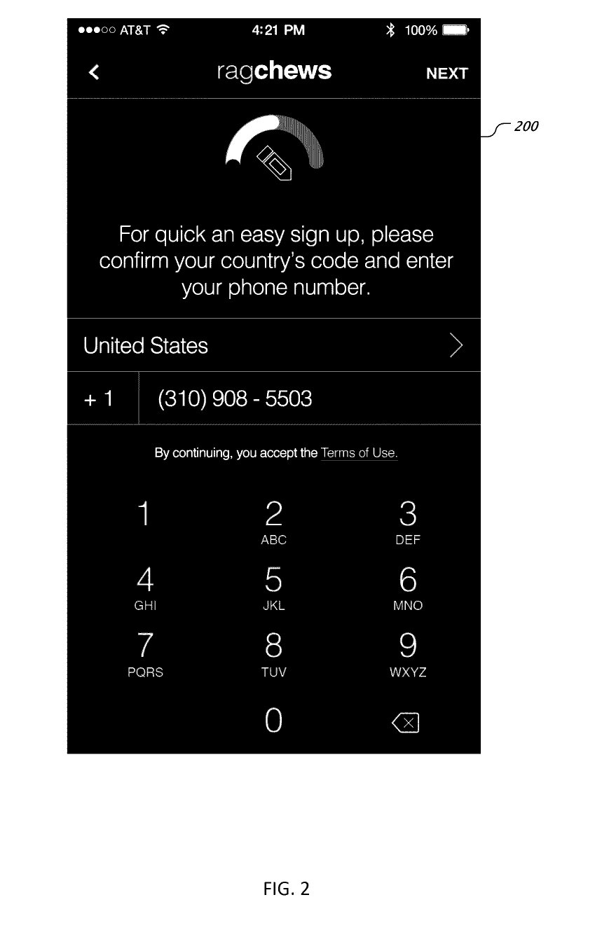

FIGS. 2-14 include example screenshots illustrating how users may utilize the system 100 to communicate with one another. Although the screenshots generally show a graphical display configured from a mobile device, similar graphical displays are available for other devices, including tablet computers, laptop computers, and personal computers. Also, while the figures generally illustrate text chat communications, the system 100 can also provide audio and/or video communications.

FIG. 2 is a screenshot of an example sign up screen 200 for a mobile device that allows a user to enter a country code and a phone number to sign up or subscribe to the communication services described herein. Once the phone number is entered, the system 100 attempts to verify that the phone number belongs to the user. A code may be sent by text message (e.g., an SMS text) to the phone number. The user may then confirm receipt of the message by entering the code.

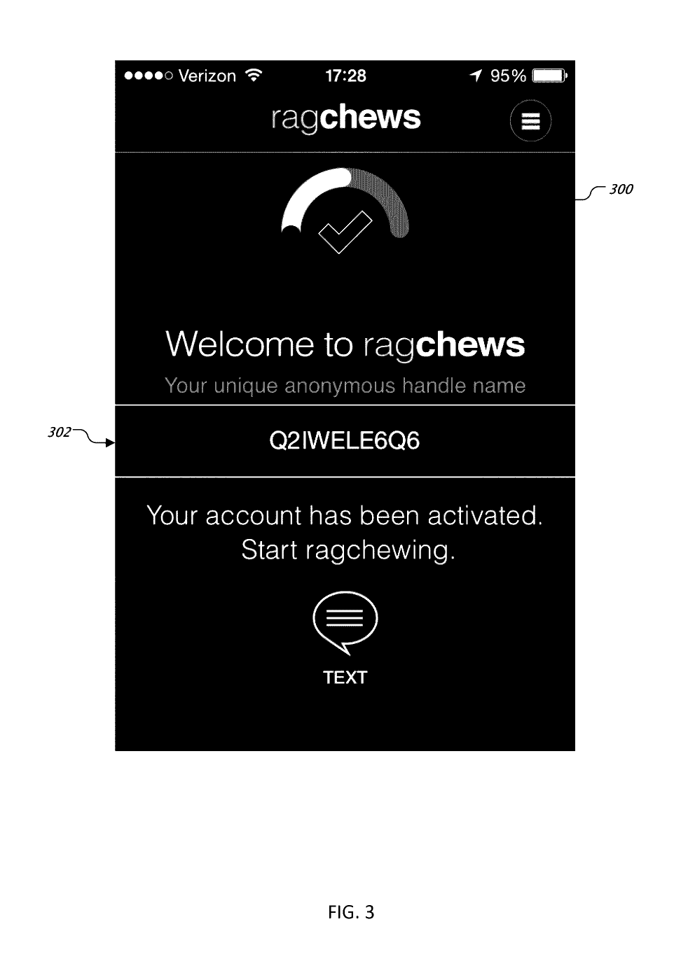

FIG. 3 is a screenshot of a welcome screen 300 that is displayed once the user's phone number is verified. At this point, the user's account is created and the user is given an anonymous handle or user number 302. The user may now use the system 100 to communicate anonymously by text chat, audio, and/or video with other users. Such anonymous communication is referred to herein as “ragchewing.” Likewise, a communication session using the system 100 may be referred to as a “ragchew session.”

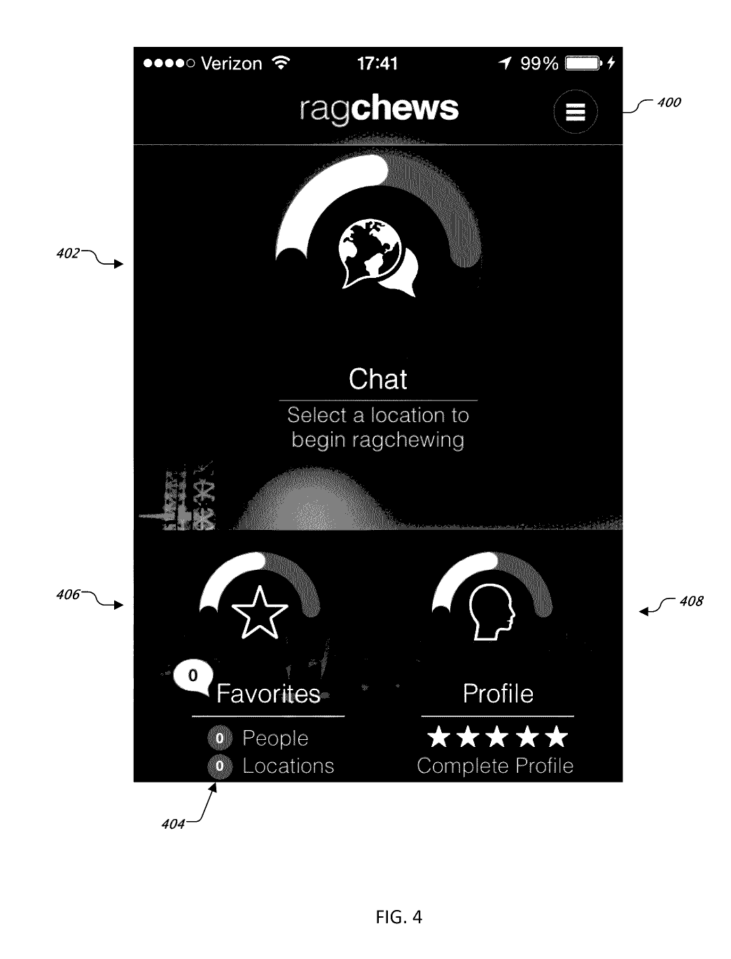

FIG. 4 is a screenshot of a home screen 400 that allows the user to initiate ragchewing with other users. The home screen 400 also allows the user to configure the user's profile (e.g., age, gender, race, and other demographic information) or preferences (e.g., language preferences, topic of conversation preferences, or time of day preferences) and add any favorite users with whom the user may wish to ragchew. Such information may be stored in the user information 122 and user favorites 126 databases, as described herein. To initiate a ragchew session, the user may click or select a chat icon 402. In the discussion that follows, the user who is initiating or requesting a ragchew session is referred to as “the requester.” Users who are receiving ragchew invitations from the requester or participating in a ragchew session with the requester are referred to as responders.

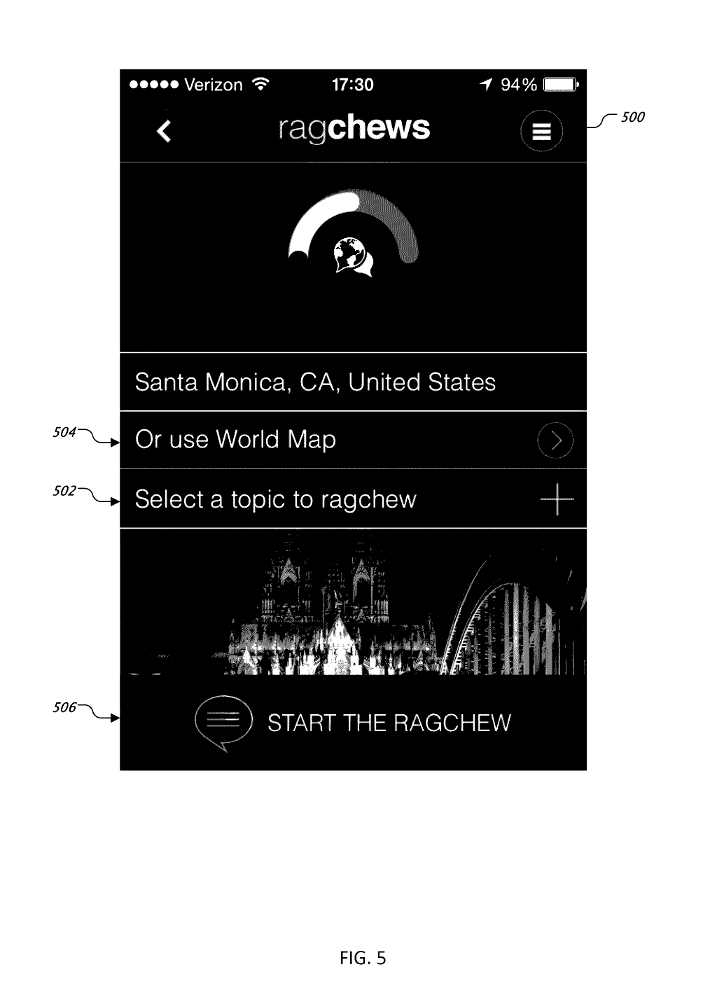

Referring to FIG. 5, upon initiating a ragchew session, the requester may be presented with a location screen 500 where the requester may specify a geographical location for a desired responder for the ragchew session. In some examples, the highest granularity (i.e., smallest size) for the geographic location that a requester can select is a city, town, village, or other region of similar size. The requester is generally not allowed to select smaller regions, such as portions of cities or exact neighborhoods. Likewise, the exact location of the requester is not shared with the responders. The systems and methods reveal only a general location (e.g., city, town, or village) of each participant to the one or more other participants involved in the ragchew session. This provides added safety, privacy, and security for the participants, and helps keep the communication anonymous. The requester may also select whether the ragchew session will use text, audio, and/or video communication. In various examples, the process of initiating a ragchew session and inviting prospective responders to participate is performed using the invitation module 116 of the system 100.

In preferred examples, the requester is not located within the specified geographical location. A distance between the requester and the geographical location may be, for example, greater than about 1 mile, greater than about 10 miles, greater than about 100 miles, greater than about 1000 miles, or greater than about 5000 miles. This allows the requester to find and communicate with people who are located in distant or remote regions.

The location screen 500 also includes a location link 502 that allows the requester to select a topic for the ragchew session. The selected topic may be shared with any prospective responders for the ragchew session. This allows the responders to know the user's desired topic before agreeing to participate in the session or before the session begins. Alternatively, the selected topic may not be shared with the prospective responders. The selected topic is generally used by the system 100 to find prospective responders who are a good match for the requester. For example, if a requester chooses food and wine as a topic for a ragchew session, and a prospective responder's user profile has food and wine as a topic of interest, then that prospective responder will be ranked higher, compared to other users who do not have food and wine as a topic of interest in their user profiles. Examples of possible topics include food and wine, hotel and accommodations, sites and destinations, music and arts, entertainment, sports and activities, current events, and politics.

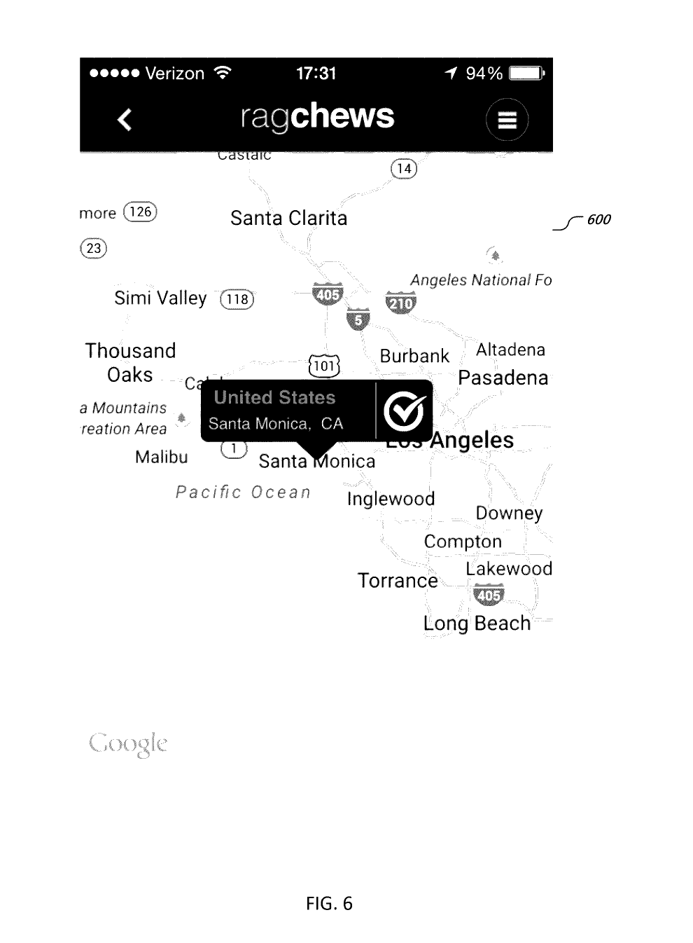

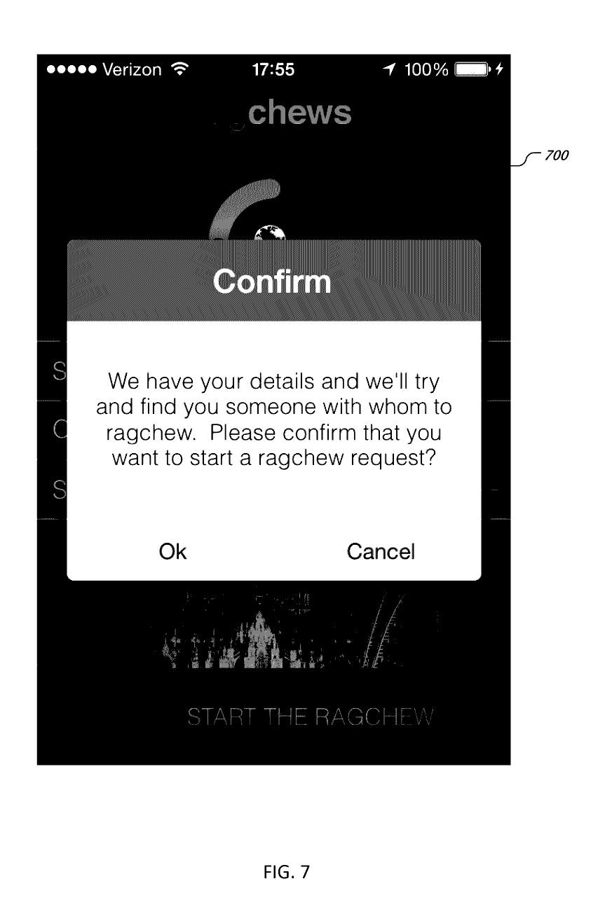

The location screen 500 also provides an option 504 to select the geographic location using a world map. When the requester selects this option, a world map 600 is displayed, as shown in FIG. 6. The requester may then specify the geographic location by selecting a desired city or similar region on the map 600. After the requester selects the geographic location from the map 600, the location screen of FIG. 5 is redisplayed. The requester can then submit a request for the ragchew session by selecting a start button 506. Referring to FIG. 7, a confirmation window 700 may be displayed that asks the requester to confirm that the ragchew session should be started.

Once the requester submits the request for a selected geographic location, the system 100 may use the participant search module 118 to search for and ping prospective responders who are currently tuned in and available in the given geographic location. The system 100 preferably finds prospective responders who are the best match for the requester and/or the particular ragchew session. The best match may be identified based on the requester's profile (e.g., age or gender), the topic of discussion (e.g., based on preferences), and/or feedback ratings from prior ragchew sessions. In general, participants who were rated highly in prior ragchew sessions are more likely to be identified as a good match for a subsequent ragchew session.

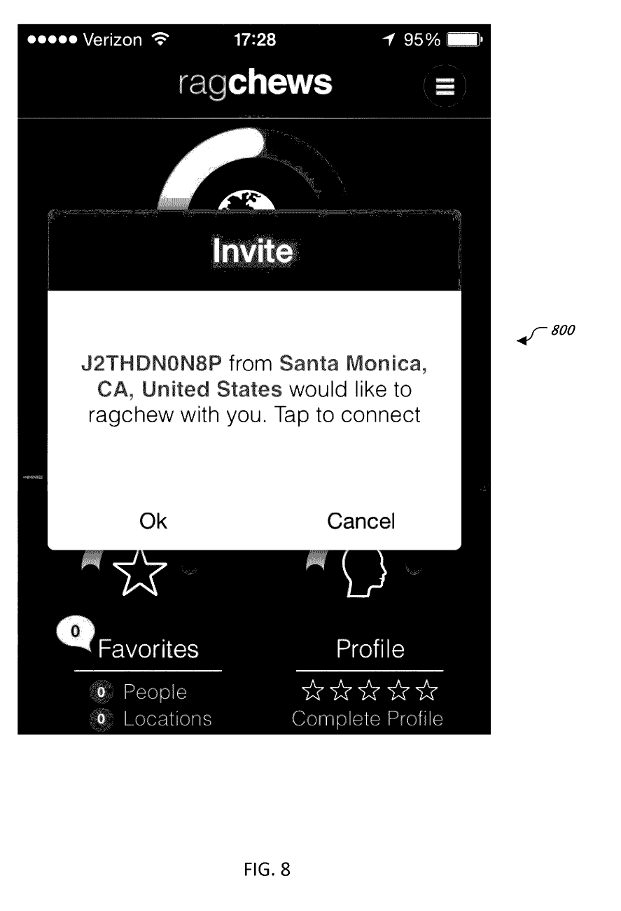

FIG. 8 is an example notification ping 800 that certain matched responders in the geographic location may receive. The notification ping 800 indicates the handle and geographic location of the requester. A responder can join the ragchew session by selecting an appropriate indicator on the notification ping 800.

In certain examples, the system 100 may simultaneously ping any number of prospective responders who are within a threshold distance of the geographic location. The number of prospective responders is configurable (e.g., by the operators of the system 100) and may be, for example, from 2 to 5, or from 5 to 10. Likewise, the threshold distance is configurable and may be, for example, from 5 to 10 miles, or from 5 to 25 miles. The prospective responder who is first to respond to the notification ping 800 is preferably chosen for the ragchew session and connected to the requester. In some instances, more than one prospective responder (e.g., the first three prospective responders to respond to the notification ping 800) may be connected simultaneously to the requester. The number of desired participants for the ragchew session is configurable and may be, for example 2, from 2 to 4, or from 2 to 10 or more. In various examples, the process of connecting the requester and one or more responders is performed using the connection and communication module 120 of the system 100.

After pinging the prospective responders, the system 100 may wait a certain amount of time (e.g., about 2 to 3 minutes) to allow one or more of the prospective responders to accept or otherwise respond to the notification ping 800. If none of the prospective responders respond to the notification ping 800, the system 100 may ping a second set of prospective responders. Additional sets of prospective participants may be pinged, as necessary, when a set of prospective responders fails to respond or declines to participate. If no prospective responders are available within the threshold radius, the threshold radius may be expanded (e.g., by up to 10, 20, or 50 miles) to include more prospective responders, who may then be pinged.

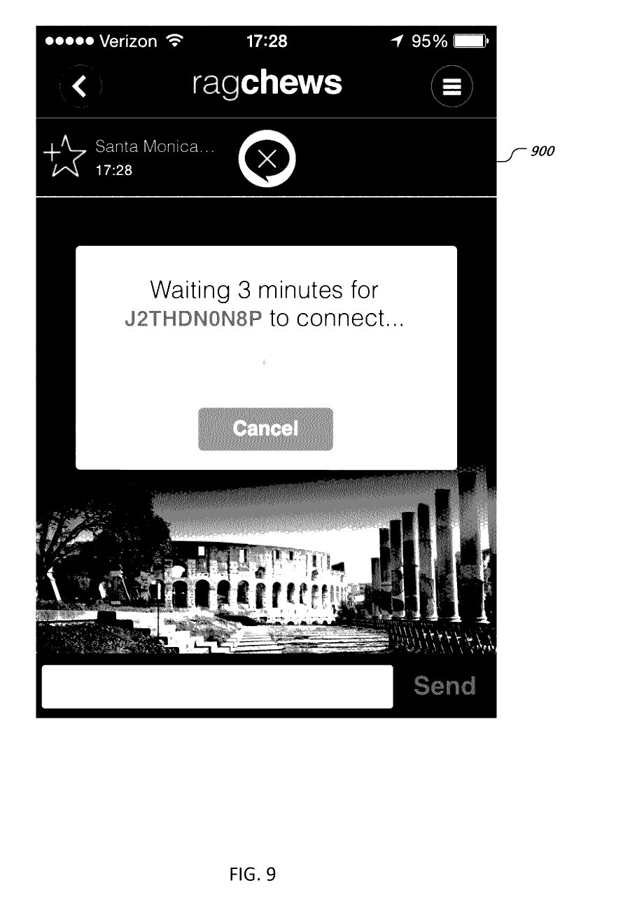

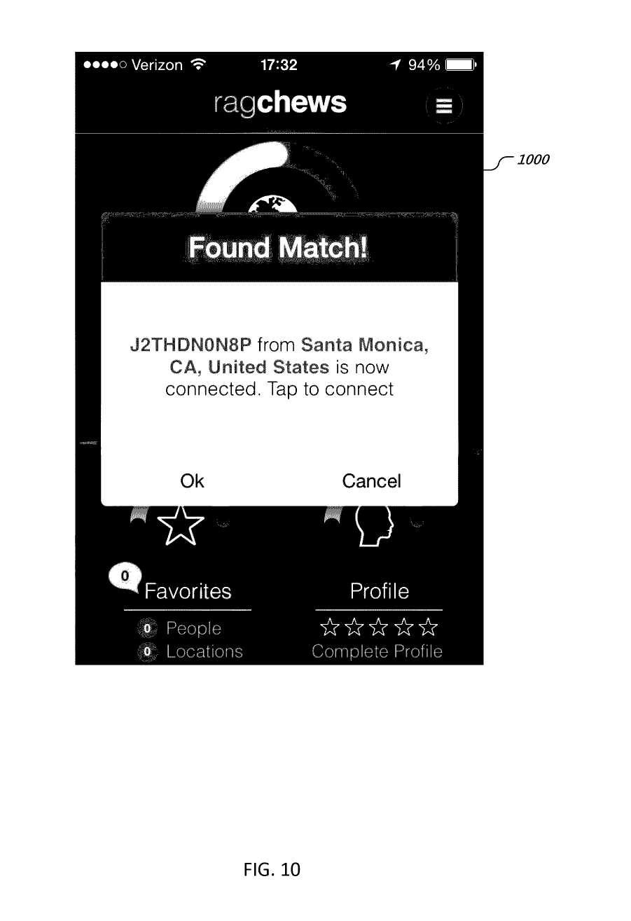

Once a responder accepts a notification ping 800, the system 100 may present an acceptance screen that notifies the requester of the acceptance. To connect the participants, the system 100 may give the requester time (e.g., about 3 minutes) to accept the session with the responder. FIG. 9 is an example notification screen 900 displayed for a responder who has accepted the notification ping 800. FIG. 10 is an example notification screen 1000 displayed for a requester after a responder has accepted the notification ping 800.

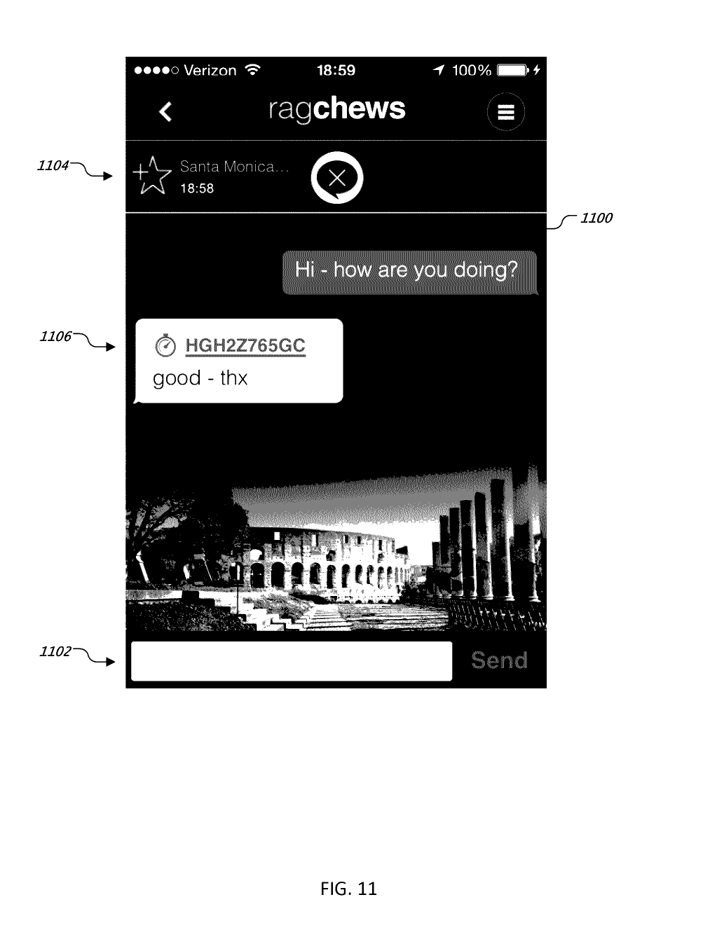

FIG. 11 is an example communication screen 1100 showing a chat session between two connected participants. The communication screen 1100 includes a text input cell 1102 where a participant can type a message for sending to the other participant(s). Previous messages exchanged by the participants are displayed in the communication screen 1100. In the depicted example, the communication screen 1100 includes a button 1104 that allows a participant to add the geographic location of another participant to a favorite locations category. Such favorite locations can be selected later by one of the users, when requesting additional ragchew sessions. The communication screen 1100 may display the current time in the geographic location of the other participant. The communication screen 1100 may indicate how many users are participating in a ragchew session and/or may display the topic of conversation.

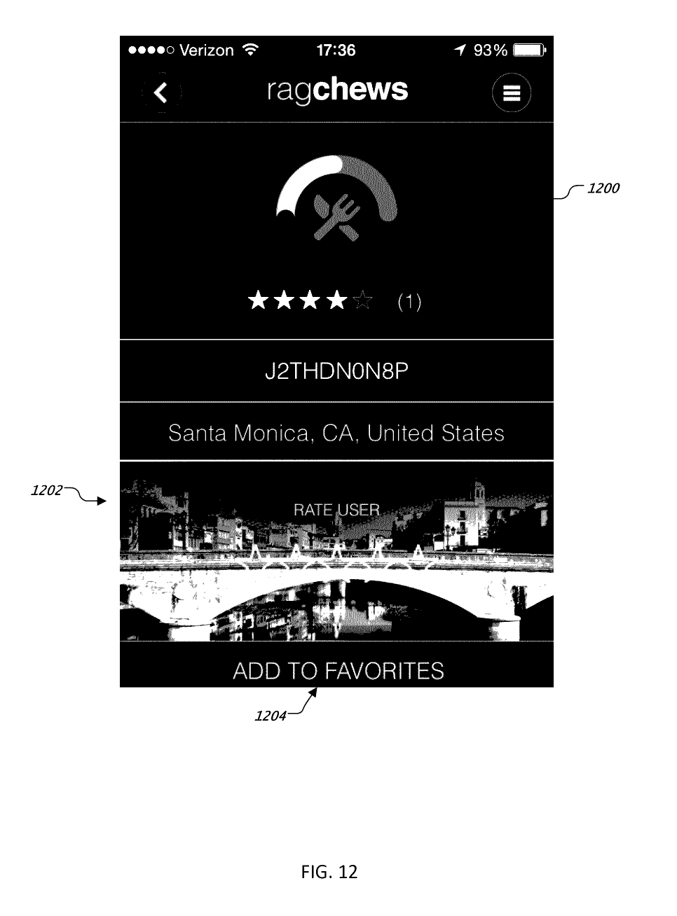

In certain implementations, participants in a ragchew session can view certain information about other participants and/or provide feedback regarding the other participants (e.g., the communication abilities and/or attitudes of the participants). For example, the communication screen 1100 may include a link 1106 to a profile of a participant. When a user selects the link 1106, a profile screen 1200 is displayed for the user, as shown in FIG. 12. The profile screen may display general information about the other participant, such as the participant's topics of interest. The profile screen preferably does not display any personally identifiable information (e.g., name or address) or similar information that can be used to identify a specific individual. This is done to maintain the privacy of the participants.

The profile screen 1200 also includes a ratings button 1202 that allows users to rate other participants. When a user has a positive experience communicating with a participant, the user may wish to give the participant a high user rating (e.g., 4 out of 5 stars). Likewise, when a user has an unfavorable experience communicating with a participant, the user may wish to give the participant a low user rating (e.g., 1 out of 5 stars). The user ratings may be used by the system 100 (e.g., the participant search module 118) to select participants for future ragchew sessions. For example, when the system 100 is searching for a prospective responder in a geographic location, the system 100 may be more likely to invite responders who have a high rating than responders who have a low rating.

The profile screen 1200 also includes a favorites button 1204 that allows users to add other participants to a favorite user category. Adding a user to the favorites category may require permission from the user being added. If the added user grants permission, each user may be added to the other user's favorite user category. A user may have the ability to remove a user from the favorite user category.

Referring again to FIG. 4, the home screen 400 may include one or more indicators 404 showing how many users are included in the favorite user category and/or how many locations are included in the favorite location category. Users may access and/or edit the favorite users and favorite locations by selecting a favorites button 406 on the home screen 400. A user may remove another user from the favorite user category, when no further contact is desired with the other user, for example, due to harassment from the other user.

In some examples, when initiating a ragchew session, rather than specifying a geographic location for the session, a requester can select a responder from the requester's favorite user category. In this case, the system 100 may ping only the selected favorite responder and may not attempt to invite any other responders. Before pinging the selected responder, the system 100 may first verify that the selected responder is available and/or that the selected responder is willing to receive additional invitations. For example, the system 100 may not ping the selected responder if that person has indicated (e.g., through user preferences) that he or she does not wish to be pinged at that time Likewise, the system 100 may not ping the selected user if that person has been pinged by more than a threshold number of times (e.g., 2 or 5, as specified in user preferences) in a given time period (e.g., 1 day). The availability of the selected user is preferably not displayed for the requester. If the selected user is not available (e.g., because of the selected user's preferences, or because the selected user did not reply to the invitation), the system 100 may inform the requester that the selected user is unavailable and may allow the requester to send an offline message to the selected user. When the selected responder accepts the invitation, a confirmation notification may be shown to the requester. The ragchew session may begin once both participants have agreed to participate.

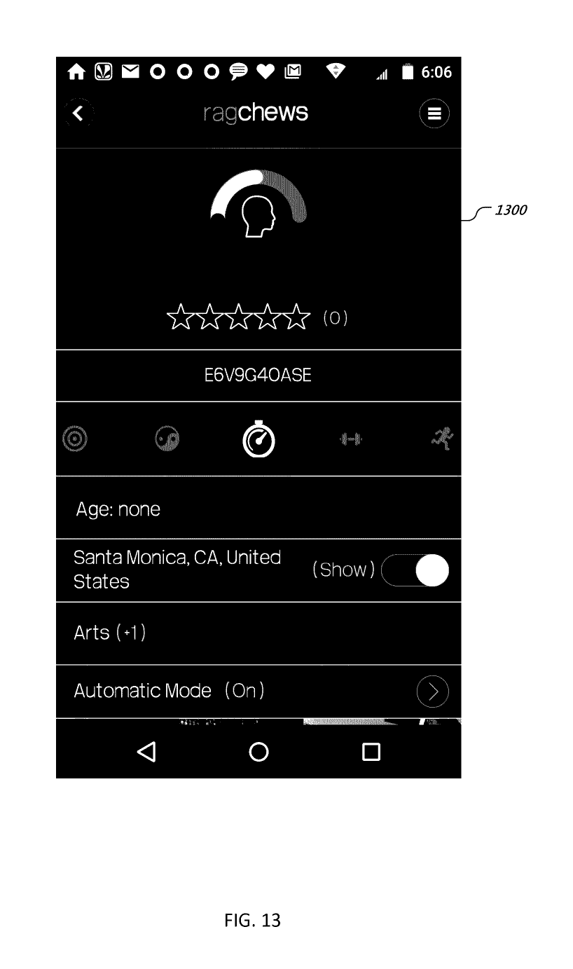

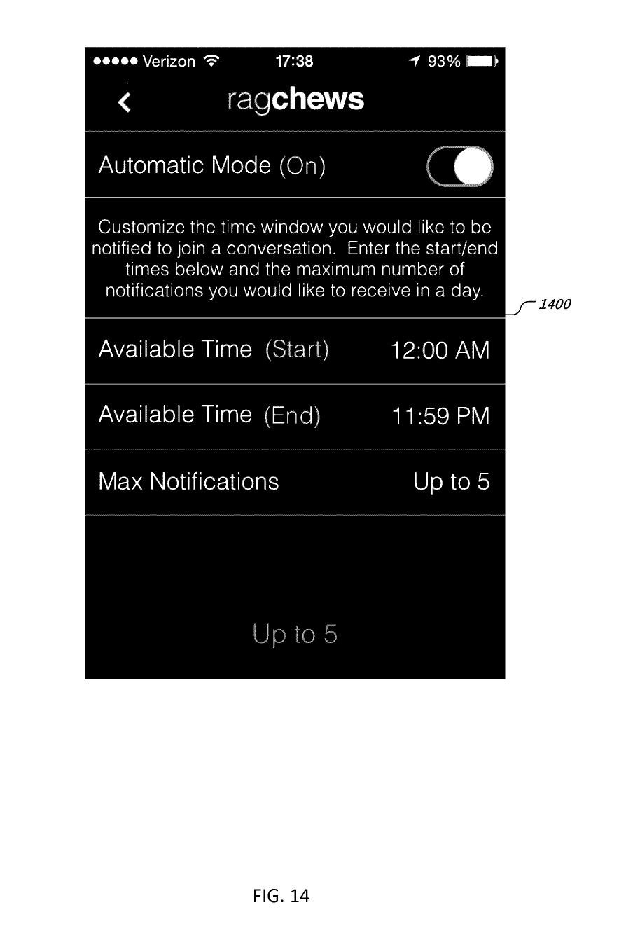

The home screen 400 also includes a profile button 408 that allows a user to set up or edit the user's profile and/or preferences. Referring to FIG. 13, when the profile button 408 is selected, a profile screen 1300 is displayed that lists the user's information and preferences. The user can input or edit information on the profile screen 1300, such as the user's age (e.g., in increments or ranges of 5 years), gender, and interests. The user may also edit certain user preferences, such as whether the user's location should be hidden during ragchew sessions (e.g., when communicating with favorites) and/or whether the user should be tuned-in manually or automatically. Referring to FIG. 14, when a user chooses to be tuned-in automatically, an accessibility screen 1400 appears in which the user can specify a window of time during each day when the user is available to be pinged by other users. The user may also specify a maximum number of times (e.g., 5, 10, 20, 35, 50, or unlimited) that the user can be pinged by other users in a single day.

In certain examples, the system 100 determines user locations based on GPS signals, cell phone tower triangulation, and/or internet IP address (e.g., on non-mobile devices where internet is not available). Cellular/internet connectivity is generally required for carrying out ragchew sessions using the system 100. On mobile and non-mobile devices, user locations may be obtained based on APIs of the platform/operating system. Open source servers based on extensible messaging and presence protocol (XMPP) may be used to carry out communication.

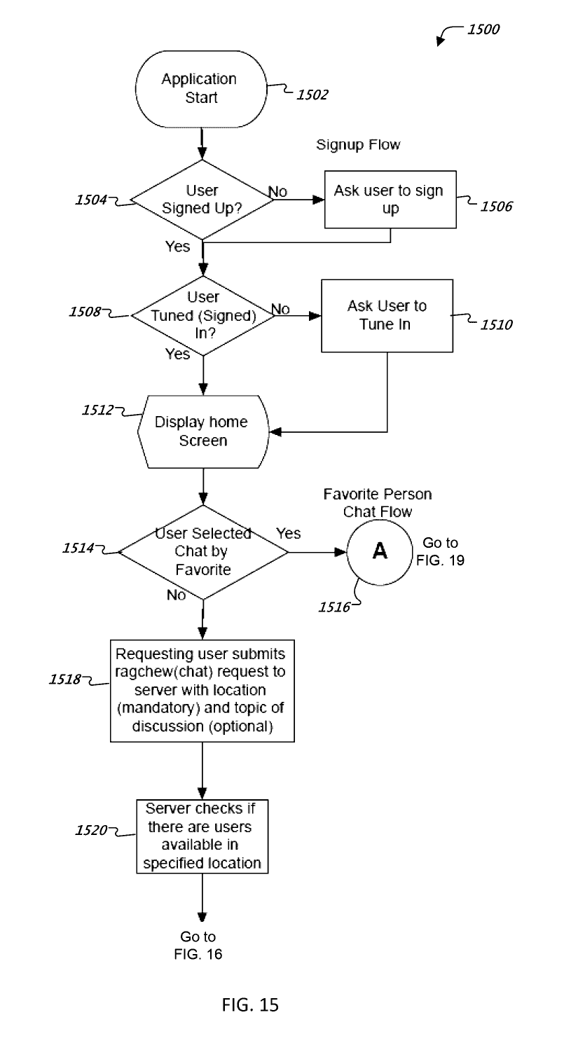

FIGS. 15 through 20 include flowcharts illustrating an example method 1500 of connecting two or more users for a communication session. The method 1500 is preferably implemented using the client devices, network, server system, software modules (e.g., software programs or application programs), and databases of the system 100.

Referring to FIG. 15, a user begins using the method 1500 at step 1502. If the user is not already signed up to use the system 100 (step 1504), the user is asked to sign up (1506). The user may then input information (e.g., a phone number) necessary to create a user account. After the user has signed up, if the user is not tuned-in and available to communicate with other users (step 1508), the user is asked to tune-in (step 1510). The user may tune-in by selecting an option on the client device and may be signed-off after a certain period of inactivity. A home screen (e.g., home screen 400) is displayed (step 1512) for the user.

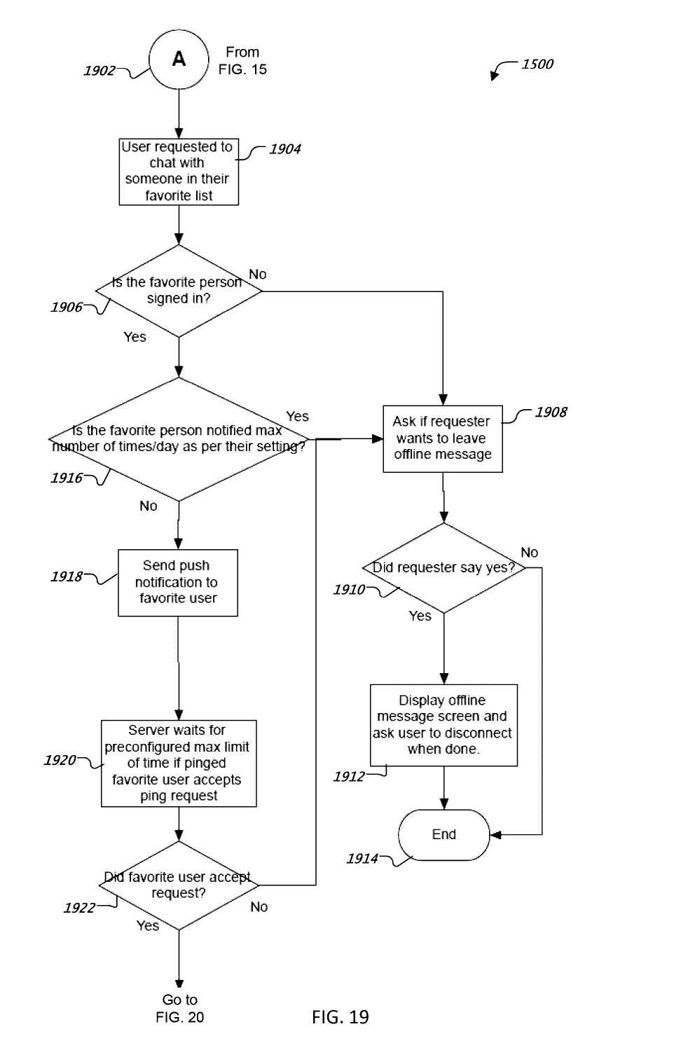

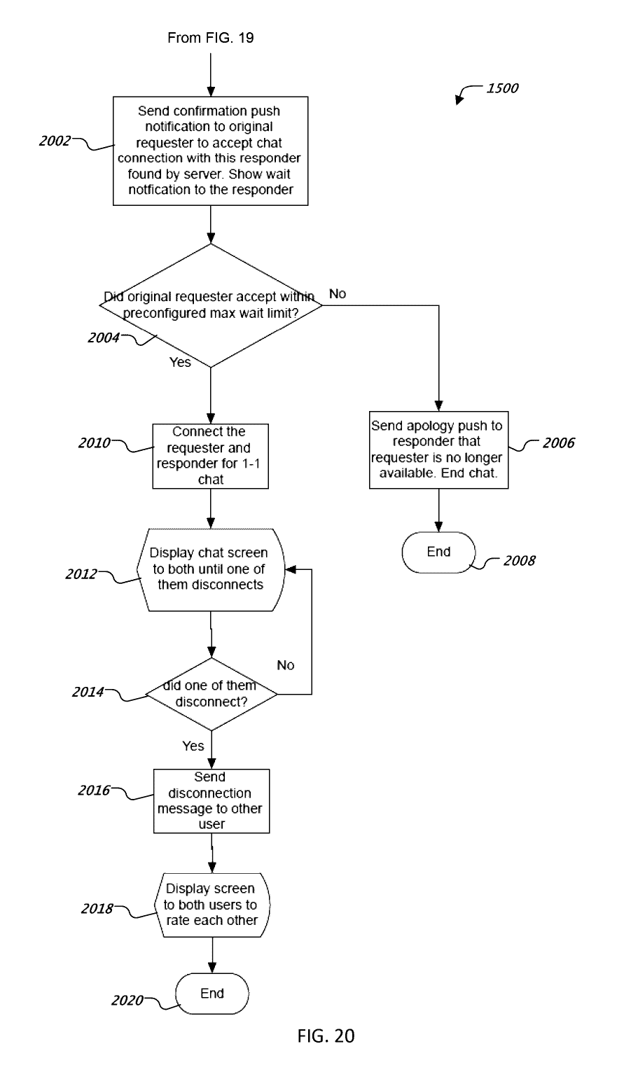

The user is now ready to initiate a ragchew session with one or more responders. If the requesting user chooses a favorite user for the ragchew session (step 1514), the requester may be connected with the favorite user (step 1516), as described herein and shown further in FIGS. 19 and 20. Otherwise, the user submits a geographic location and optionally a topic for the ragchew session (step 1518). A search is performed (step 1520) for prospective responders who are available within a specified distance of the geographic location.

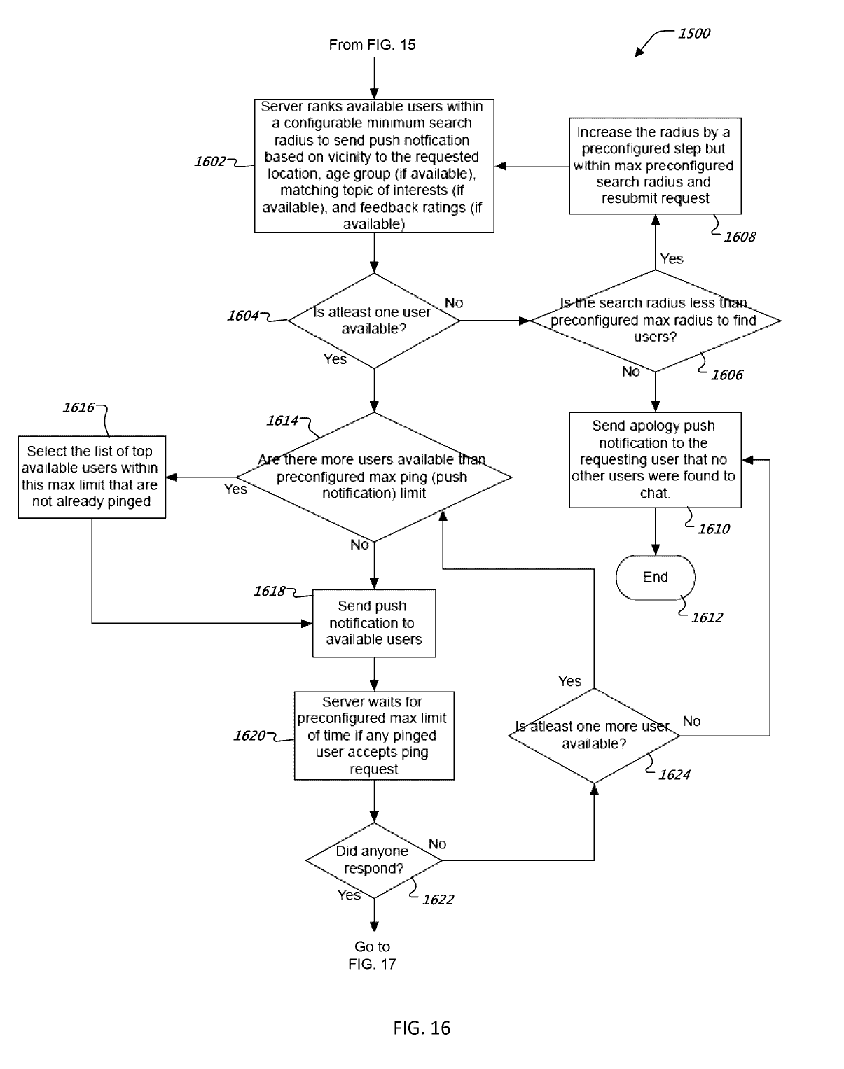

Referring to FIG. 16, available prospective responders are ranked (step 1602) according to various factors, including a distance between each prospective user and the geographic location, an age of each prospective responder, a gender of each prospective responder, the topic for the ragchew session, and/or user feedback ratings. If no prospective users are available within the specified distance of the geographic location (step 1604), it is determined (step 1606) whether the search radius or distance from the geographic location can be further increased. If the search distance is less than a specified maximum, the search distance is increased (step 1608) to include more prospective responders within the search area. Any prospective responders may then be ranked (step 1602), and the search area may be further increased (step 1608), as necessary. If the search distance is greater than or equal to the specified maximum and no prospective users are available (step 1606), the requester is informed (step 1610) that no prospective users are available and the session is terminated (step 1612).

After the system identifies (step 1604) at least one prospective responder within the search area (i.e., within a specified distance of the geographic location), it is determined (step 1614) if there are more prospective responders available than a preconfigured maximum. If the number of prospective responders exceeds the preconfigured maximum, the top ranked prospective responders within the preconfigured maximum are selected (step 1616). Invitations (e.g., notification pings 800) are then sent (step 1618) to the selected prospective responders. The prospective responders are given a certain amount of time (e.g., 2-3 minutes) to accept or otherwise respond to the invitations (step 1620). If no prospective responders accept the invitations (step 1622), it is determined (step 1624) if any other prospective responders are available and, if so, invitations are sent (step 1618) to those other prospective responders. If no prospective responders accept the invitations (step 1622) and no other prospective responders are available (step 1624), the requester is informed (step 1610) that no prospective responders are available for the ragchew session and the session is terminated (step 1612).

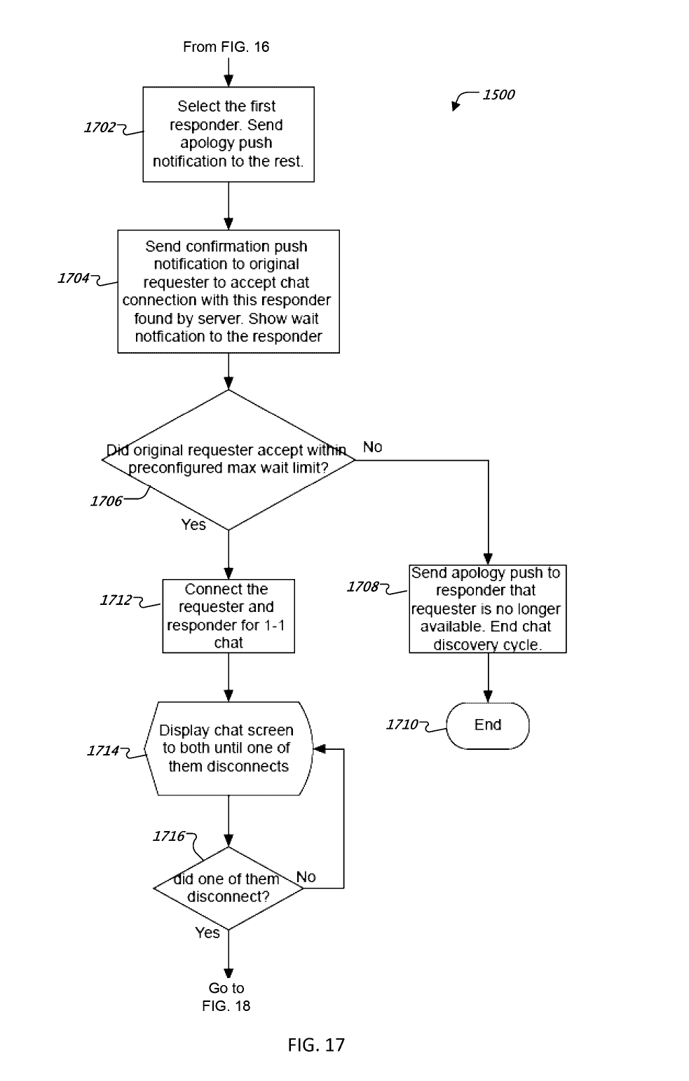

Referring to FIG. 17, after one or more prospective responders have accepted the invitation, the first prospective responder is selected to join the ragchew session (step 1702). Alternatively, two or more of the prospective responders may be selected to join the ragchew session (e.g., if the requester is looking to communicate with more than one other responder). Any prospective responders who accepted the invitation but are not selected for the ragchew session may receive a notification indicating that they were not selected. The requester is then asked to confirm that he or she wants to proceed with the ragchew session with the selected responder (step 1704). The selected responder is asked to wait until the ragchew session begins. If the requester does not provide confirmation within a maximum wait time (step 1706), the responder is informed (step 1708) that the requester is no longer available and the requester's proposed ragchew session is terminated (step 1710).

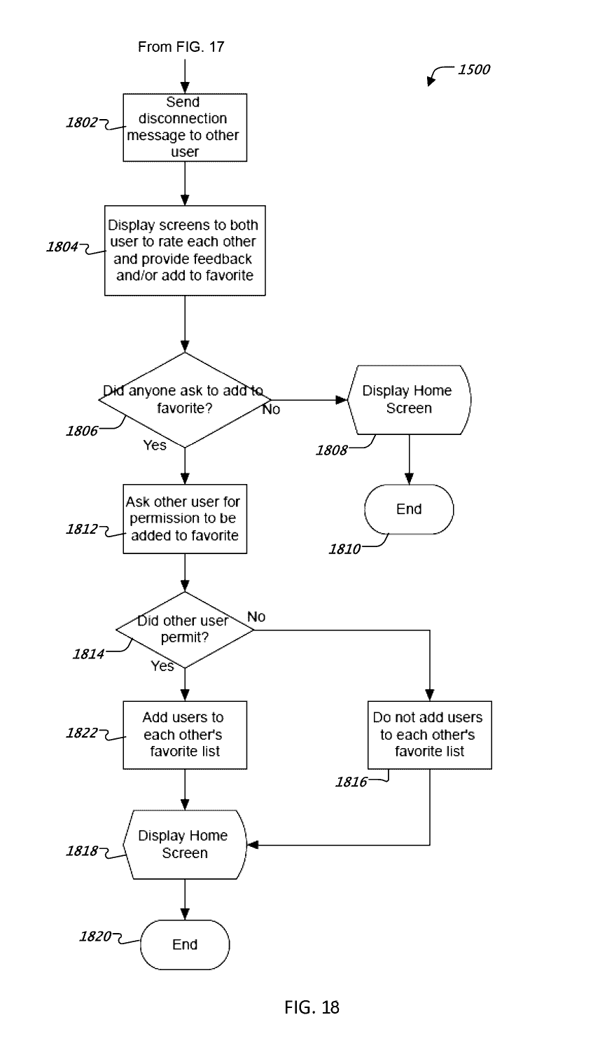

Otherwise, if the requester provides confirmation to proceed with the ragchew session (step 1706), the requester and responder are connected and may communicate using text messages, audio, and/or video (step 1712). A communication screen (e.g., communication screen 1100) is displayed for the participants (step 1714). Once one of the participants disconnects or otherwise ends the ragchew session (step 1716), the other participant is notified that the session is over (step 1802), as shown in FIG. 18. Each participant is then given an opportunity to rate the other participant (e.g., using the profile screen 1200) and/or add the other participant to the favorite users category (step 1804). If neither participant is added to the other participant's favorite users category (step 1806), the home screen 400 is displayed (step 1808) and the ragchew session is terminated (step 1810).

Otherwise, if one of the participants attempts to add the other participant to the favorite users category (step 1806), the other participant is asked for permission to be added as a favorite user (step 1812). If permission is not granted (step 1814), neither participant is added to the other participant's list of favorite users (step 1816), the home screen 400 is displayed (step 1818), and the ragchew session is terminated (step 1820). Otherwise, if permission is granted (step 1814), each participant is added to the other participant's list of favorite users (step 1822), the home screen 400 is displayed step (1818), and the ragchew session is terminated (step 1820).

Referring to FIG. 19, in certain instances, a requester may choose to initiate a ragchew session with one or more favorite responders from the requester's list of favorite users (step 1902). Upon receiving the request from the requester (step 1904), it is determined if the favorite responder is signed in (step 1906). If the favorite responder is not signed in, the requester is given an option to send an offline message to the favorite responder (step 1908). If the requester chooses to send the offline message (step 1910), an offline message screen (e.g., including a text message input cell with a virtual keyboard) is provided to the requester (step 1912) to compose the offline message. The requester is asked to log off when done composing the offline message, and the ragchew session is terminated when the requester logs off or otherwise terminates the session (step 1914). The offline message may be sent to the favorite responder. If the requester chooses to not send the offline message, the ragchew session is terminated (step 1914).

Otherwise, if the favorite responder is signed in, it is determined if the favorite responder is available for the ragchew session (step 1916). If the favorite responder is not available (e.g., the maximum number of notifications has been exceeded), the requester is given the option of sending an offline message to the favorite responder (step 1908), and steps 1910, 1912, and 1914 may be repeated. Alternatively, if the favorite responder is available, an invitation (e.g., notification ping 800) is sent to the favorite responder (step 1918), and the favorite responder is given time (e.g., 2-3 minutes) to respond to the invitation (step 1920). If the favorite responder does not accept the notification within the allotted time (step 1922), steps 1908, 1910, 1912, and 1914 may be repeated.

Referring to FIG. 20, if the favorite responder accepts the invitation, the requester is asked to confirm his or her desire to proceed with the ragchew session (step 2002). If the requester does not provide confirmation within an allotted time (step 2004), the favorite responder is informed that the requester is no longer available (step 2006) and the proposed ragchew session is terminated (step 2008). Alternatively, once the requester provides confirmation (step 2004), the requester and the favorite responder are connected for the ragchew session (step 2010). A communication screen (e.g., communication screen 1100) is displayed for the participants (step 2012). Once one of the participants disconnects or otherwise ends the ragchew session (step 2014), the other participant is notified that the session is over (step 2016). Each participant is then given an opportunity (step 2018) to rate the other participant (e.g., using the profile screen 1200), and the ragchew session is terminated (step 2020).

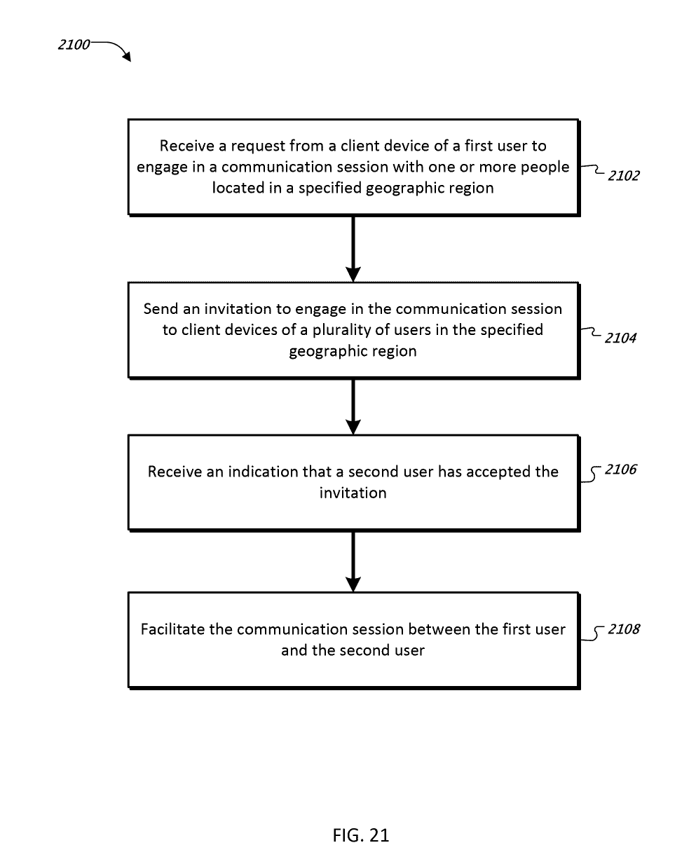

FIG. 21 is a flowchart of an example method 2100 of connecting two or more users for a communication session. A request is received (step 2102) from a client device (e.g., a mobile phone) of a requester to engage in a communication session with one or more responders located in a specified geographic region. An invitation to engage in the communication session is sent (step 2104) to client devices of one or more prospective responders in the specified geographic region. When one or more prospective responders accept the invitation, an indication is received (step 2106) that at least one responder has accepted the invitation. A communication session between the requester and the responder is then facilitated (step 2108).

The method 2100 is preferably implemented using the client devices, network, server system, software modules, and databases of the system 100. For example, the invitation module 116 may be used to receive the request from the requester and to send the invitation to the prospective responders. The participant search module 118 may be used to identify the one or more prospective responders. The connection and communication module 120 may be used to facilitate the communication session between the requester and the responder.

In certain implementations, the participant search module 118 searches for available prospective responders and attempts to find a best match for the requester. As described herein, the requester specifies the desired geographic location (e.g., city, village, or town) for the ragchew session. The requester can also choose a topic of conversation (e.g., one of the requester's preferred topics of interest) for the ragchew session (e.g., at the time the ragchew session is requested). Once the request is received by the system 100, the city, town, village of the request is preferably converted into a specific latitude and longitude using one or more application program interfaces (APIs), which may be open source. The server system 112 preferably monitors the latitude and longitude of logged in users and refreshes this location information periodically, to make sure the information is current, in case one or more users are moving. The system 100 may then find all logged in users who are located within a specified radius (e.g., 5 miles) of the latitude and longitude of the geographic location. Once a listing of logged in users has been identified, the system 100 may filter out users who are not available for the ragchew session (e.g., because of their time preferences and/or because they have been pinged more than their threshold limits). At this point, the system 100 has identified a list of prospective responders who are in the desired location and are available to participate in the ragchew session.

With a list of available prospective responders identified, the system 100 may then attempt to determine the prospective responder who is the best match for the requested ragchew session. In one implementation, the system 100 ranks the available prospective responders according to the following factors: user ratings, topic of conversation, and user age range. For example, the system 100 may rank prospective responders according to user ratings, with more highly rated users receiving the highest ranking. If the requester provided a topic of conversation, the system 100 may adjust the rankings according to any topics of interest associated with the prospective responders (e.g., in their user preferences). For example, a prospective responder having a topic of interest that matches the desired topic of conversation may be ranked higher than a prospective user who does not have a matching topic of interest. The system 100 may also adjust the rankings according to user age. In general, prospective responders who are close in age to the age of the requester will be ranked more highly. Each factor may be given a numerical value, and weights may be applied (e.g., to weigh user ranking more than user age range). This allows a match score to be determined for each of the available prospective users. Data science may be used to identify combinations of these factors and/or weights that result in the best match. Users having the highest match score may receive invitations to participate in the ragchew session.

As mentioned herein, if no logged in users are identified in the initial search of a geographic location, the system 100 may need to increase the search radius (e.g., from 5 miles to 10 miles). The radius may be further increased (e.g., in increments of 5 or 10 miles), as necessary, until a maximum threshold radius is reached. If no available users are found within the maximum radius, the system 100 may end its search and notify the requester accordingly. As an example, if the requester specified San Francisco, Calif. as the geographic location, the system 100 may find an available prospective responder in Menlo Park, Calif. (located about 30 miles from San Francisco, Calif.) when the search radius is increased to encompass Menlo Park. In some implementations, data science is used to determine an optimal initial search radius (e.g., based on population density and/or a number of users in a geographic area). Data science may also be used to determine optimal increments for increasing the search radius when no prospective responders are found in the current search radius.

In certain embodiments, the connection and communication module 120 achieves text, audio, and/or video communications using various techniques and protocols. Text communications may be achieved using text over IP (or ToIP) methodologies. Text communications may be achieved using XMPP protocol (e.g., open source XMPP server TIGASE). Audio and/or video communications may be achieved using, for example, H.323, Media Gateway Control Protocol (MGCP), Session Initiation Protocol (SIP), H.248, Real-time Transport Protocol (RTP), Real-time Transport Control Protocol (RTCP), Secure Real-time Transport Protocol (SRTP), Session Description Protocol (SDP), Inter-Asterisk eXchange (IAX), Jingle XMPP VoIP extensions, SKYPE protocol, and TEAMSPEAK.

To maintain the anonymity of the users, the system can employ audio and/or video synthesizers. Such synthesizers may mask or alter a user's vocal characteristics and/or appearance, thereby making it more difficult for the user to be identified by other users.

In preferred embodiments, text messages exchanged between users (e.g., the requester and the responder) are done using an instant chat application or other explicit connection that allows direct chatting between the users. The text messages are preferably not exchanged using push notifications or similar mechanisms.

Implementations of the subject matter and the operations described in this specification can be implemented in digital electronic circuitry, or in computer software, firmware, or hardware, including the structures disclosed in this specification and their structural equivalents, or in combinations of one or more of them. Implementations of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a non-transitory computer storage medium or device, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what can be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features can be described above as acting in certain combinations and even initially claimed as such, one or more features from a claimed combination can in some cases be excised from the combination, and the claimed combination can be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing can be advantageous. For example, parallel processing can be used to perform multiple emoji detection methods simultaneously. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing can be advantageous.

What is claimed is:

1. A method comprising:
using one or more computer processors to perform operations comprising:
receiving a request from a client device of a first user to engage in a communication session with one or more people located in a specified geographic region;
determining a first latitude and a first longitude for the specified geographic region;
defining a target region to be within a specified radius of the first latitude and the first longitude;
identifying at least one second user in the target region who is a suitable candidate for the communication session based on a user rating and a time preference, the user rating comprising feedback from one or more other users relating to the at least one second user from a previous communication session, the time preference comprising a preferred time period for the second user for participating in communication sessions, wherein identifying the at least one second user comprises determining a second latitude and a second longitude for the at least one second user and determining, based on the second latitude and the second longitude, that the at least one second user is located within the target region;
sending an invitation to engage in the communication session to one or more client devices of the at least one second user in the target region;
receiving an indication that the at least one second user has accepted the invitation; and
facilitating the communication session between the first user and the at least one second user.

2. The method of claim 1, wherein the communication session comprises a communication type selected from the group consisting of a text communication, an audio communication, a video communication, and combinations thereof.

3. The method of claim 1, wherein the specified geographic region is selected from the group consisting of a town, a city, a village, a county, a province, and a country.

4. The method of claim 1, wherein the one or more people are not known to the first user.

5. The method of claim 1, wherein the at least one second user comprises a plurality of second users, and the invitation is sent to the client devices of the plurality of second users simultaneously.

6. The method of claim 1, wherein identifying the at least one second user further comprises determining that the at least one second user has not been invited to prior communication sessions more than a preferred maximum number of times.

7. The method of claim 1, wherein the invitation comprises a proposed topic for the communication session.

8. The method of claim 1, wherein identifying the at least one second user further comprises ranking a plurality of second users according to at least one factor selected from the group consisting of user ratings for the second users, topics of interest for the second users, and ages for the second users.

9. The method of claim 1, wherein the one or more client devices of the at least one second user comprise mobile phones.

10. The method of claim 1, wherein identifying at least one second user comprises:
determining that there are no suitable candidates for the communication session in the target region; and
incrementing the radius for the target region to a larger size.

11. A system comprising:
a non-transitory computer readable medium having instructions stored thereon; and
a data processing apparatus configured to execute the instructions to perform operations comprising:
receiving a request from a client device of a first user to engage in a communication session with one or more people located in a specified geographic region;
determining a first latitude and a first longitude for the specified geographic region;
defining a target region to be within a specified radius of the first latitude and the first longitude;
identifying at least one second user in the target region who is a suitable candidate for the communication session based on a user rating and a time preference, the user rating comprising feedback from one or more other users relating to the at least one second user from a previous communication session, the time preference comprising a preferred time period for the second user for participating in communication sessions, wherein identifying the at least one second user comprises determining a second latitude and a second longitude for the at least one second user and determining, based on the second latitude and the second longitude, that the at least one second user is located within the target region;
sending an invitation to engage in the communication session to one or more client devices of the at least one second user in the target region;
receiving an indication that the at least one second user has accepted the invitation; and
facilitating the communication session between the first user and the at least one second user.

12. The system of claim 11, wherein the communication session comprises a communication type selected from the group consisting of a text communication, an audio communication, a video communication, and combinations thereof.

13. The system of claim 11, wherein the specified geographic region is selected from the group consisting of a town, a city, a village, a county, a province, and a country.

14. The system of claim 11, wherein the one or more people are not known to the first user.

15. The system of claim 11, wherein the at least one second user comprises a plurality of second users, and the invitation is sent to the client devices of the plurality of second users simultaneously.

16. The system of claim 11, wherein identifying the at least one second user further comprises determining that the at least one second user has not been invited to prior communication sessions more than a preferred maximum number of times.

17. The system of claim 11, wherein the invitation comprises a proposed topic for the communication session.

18. The system of claim 11, wherein identifying the at least one second user further comprises ranking a plurality of second users according to at least one factor selected from the group consisting of user ratings for the second users, topics of interest for the second users, and ages for the second users.

19. The system of claim 11, wherein the one or more client devices of the at least one second user comprise mobile phones.

20. A computer program product stored in one or more non-transitory storage media for controlling a processing mode of a data processing apparatus, the computer program product being executable by the data processing apparatus to cause the data processing apparatus to perform operations comprising:
receiving a request from a client device of a first user to engage in a communication session with one or more people located in a specified geographic region;
determining a first latitude and a first longitude for the specified geographic region;
defining a target region to be within a specified radius of the first latitude and the first longitude;
identifying at least one second user in the target region who is a suitable candidate for the communication session based on a user rating and a time preference, the user rating comprising feedback from one or more other users relating to the at least one second user from a previous communication session, the time preference comprising a preferred time period for the second user for participating in communication sessions, wherein identifying the at least one second user comprises determining a second latitude and a second longitude for the at least one second user and determining, based on the second latitude and the second longitude, that the at least one second user is located within the target region;
sending an invitation to engage in the communication session to one or more client devices of the at least one second user in the target region;
receiving an indication that the at least one second user has accepted the invitation; and
facilitating the communication session between the first user and the at least one second user.

21. The method of claim 1, further comprising:
determining that the communication session has been terminated; and
repeating the sending step, the receiving an indication step, and the facilitating step.

22. The method of claim 1, further comprising:
receiving a second request from the client device of the first user to engage in a second communication session with a favorite user;
sending a second invitation to engage in the second communication session to a client device of the favorite user;
receiving an indication that the favorite user has accepted the second invitation; and
facilitating the second communication session between the first user and the favorite user.
